(19) United States
(12) Patent Application Publication
(10) Pub. No.: US 2025/0362457 A1
(43) Pub. Date: Nov. 27, 2025

(54) OPTICAL INTERCONNECTION INTERFACE, PROCESSOR AND SERVER

(71) Applicant: IEIT SYSTEMS CO., LTD., Jinan, Shandong (CN)

(72) Inventors: Zhe XU, Jinan, Shandong (CN); Xin ZHANG, Jinan, Shandong (CN); Chen LI, Jinan, Shandong (CN)

(73) Assignee: IEIT SYSTEMS CO., LTD., Jinan, Shandong (CN)

(21) Appl. No.: 18/873,646

(22) PCT Filed: Feb. 16, 2023
(86) PCT No.: PCT/CN2023/076530

§ 371 Date: Dec. 10, 2024

(30) Foreign Application Priority Data
Sep. 2, 2022 (CN) 202211068225.1

(51) Int. Cl. G02B 6/32

(52) U.S. Cl. CPC G02B 6/32

(57) ABSTRACT

Disclosed are an optical interconnection interface, a processor and a server, which relate to the technical field of optical processors. The optical interconnection interface includes two transmission apparatuses for transmitting a light beam, where end surfaces of the two transmission apparatuses are oppositely arranged; two focusing apparatuses for focusing the light beam emitted by the two transmission apparatuses and forming a focused light beam, where the two focusing apparatuses are connected to the two opposite end surfaces of the two transmission apparatuses respectively; and a suspended interconnection medium, where the interconnection medium is captured by a capturing optical field between the two focusing apparatuses and is located between the two focusing apparatuses in response to a need for interconnection and communication of a signal.

### CROSS-REFERENCE TO RELATED APPLICATIONS

The present application is a National Stage Application of PCT International Application No. PCT/CN2023/076530 filed on Feb. 16, 2023, which claims priority to Chinese Patent Application 202211068225.1, filed in the China National Intellectual Property Administration on Sep. 2, 2022, the disclosure of which is incorporated herein by reference in its entirety.

### TECHNICAL FIELD

The present disclosure relates to the technical field of optical processors, and in particular to an optical interconnection interface, a processor and a server.

### BACKGROUND

In optical fiber communication, information is transmitted from one place to another place for communication with an optical wave as a carrier and an optical fiber as a transmission medium. An optical fiber communication technology has rapidly developed in the past few decades and has been widely used in a structure of a long-distance large-capacity communication network. However, as an optical computing technology develops from the field of space to the field of a processor, a spatial optical interconnection technology based on a traditional optical fiber has been unable to satisfy the requirements of on-processor high-density integration and short-distance high-speed communication.

The optical interconnection technology transmits data by means of a waveguide, and features low loss, rapid speed and short delay in signal transmission. Moreover, a photon has multiple physical dimensions such as frequency, polarization, time, complex amplitude, spin angular momentum and spatial structure, which will develop the optical interconnection technology into a multidimensional hybrid multiplexing technology to further increase a bandwidth of optical interconnection.

An optical tweezers (OTs) technology, also known as a single beam gradient force trap, captures, manipulates, and controls tiny particles by means of a three-dimensional potential trap formed from a highly focused laser beam, and can be used in the aspect of moving the cells or virus particles, for shaping cells into various shapes, or cooling atoms. Although the OTs technology has been successfully applied for ages, a processor that uses the OTs technology at present includes nanoscale small particles. The nanoscale particles can only be adsorbed onto a surface of a processor structure, and cannot be spatially suspended or achieve an on-processor optical interconnection effect, resulting in an incapability of satisfying the requirements of interconnection with high-speed optical communication and high bandwidth in the future.

### SUMMARY

An objective of the present disclosure is to provide an optical interconnection interface, a processor and a server, so as to achieve on-processor optical interconnection.

In order to solve the above technical problem, some embodiments of the present disclosure provide an optical interconnection interface, including:
two transmission apparatuses for transmitting a light beam, end surfaces of the two transmission apparatuses are oppositely arranged;
two focusing apparatuses for focusing the light beam emitted by the two transmission apparatuses and forming a focused light beam, the two focusing apparatuses are connected to the two opposite end surfaces of the two transmission apparatuses respectively; and
an interconnection medium, the interconnection medium is in a suspended state;
the interconnection medium is captured by a capturing optical field between the two focusing apparatuses and is located between the two focusing apparatuses in response to a need for interconnection and communication of a signal.

In some embodiments, in the optical interconnection interface, the two transmission apparatuses are waveguides.

In some embodiments, in the optical interconnection interface, the two focusing apparatuses are nanofocusing lenses.

In some embodiments, in the optical interconnection interface, the interconnection medium is a nanowire, and an included angle between a long axis of the nanowire and an axis of each transmission apparatus is adjusted according to a polarization property of the focused light beam. In some embodiments, in the optical interconnection interface, the nanowire has at least two different sizes.

In some embodiments, in the optical interconnection interface, the waveguides, the nanofocusing lenses and the nanowire are all made of non-metallic materials.

In some embodiments, in the optical interconnection interface, the waveguides, the nanofocusing lenses and the nanowire are all made of silicon.

In some embodiments, in the optical interconnection interface, focuses of the two nanofocusing lenses intersect at the same point.

In some embodiments, in the optical interconnection interface, a distance between focuses of the two nanofocusing lenses is greater than zero.

In some embodiments, in the optical interconnection interface, the two transmission apparatuses are arranged on the same processor.

In some embodiments, in the optical interconnection interface, the two transmission apparatuses are arranged on different processors.

In some embodiments, in the optical interconnection interface, the nanowire has a cross-section shape of any one of a circle, an ellipse, a rectangle, a triangle and a hexagon.

In some embodiments, in the optical interconnection interface, the nanowire has a cross-section diameter ranging from 10 nm to 250 nm in a case that the nanowire has the cross-section shape of the circle.

In some embodiments, in the optical interconnection interface, end surfaces of the waveguides are located in a range of surfaces connected to the nanofocusing lenses.

In some embodiments, in the optical interconnection interface, the waveguides have a thickness ranging from 50 nm to 300 nm and a width ranging from 50 nm to 300 nm.

In some embodiments, in the optical interconnection interface, the nanofocusing lenses are hemispherical, and have a diameter ranging from 50 nm to 350 nm.

In some embodiments, in the optical interconnection interface, each focusing apparatus and each transmission apparatus are of an integrated structure.

Some other embodiments of the present disclosure further provide a processor. The processor includes the optical interconnection interface of any one of the above.

Still some other embodiments of the present disclosure further provide a server. The server includes the above processor.

The optical interconnection interface according to the present disclosure includes the two transmission apparatuses for transmitting the light beam, the end surfaces of the two transmission apparatuses are oppositely arranged; the two focusing apparatuses for focusing the light beam emitted by the transmission apparatuses and forming the focused light beam, the two focusing apparatuses are connected to the two opposite end surfaces of the two transmission apparatuses respectively; and the suspended interconnection medium. The interconnection medium is captured by the capturing optical field between the two focusing apparatuses and is located between the two focusing apparatuses in response to a need for interconnection and communication of the signal.

It may be seen that the optical interconnection interface in the present disclosure includes the transmission apparatuses, the focusing apparatuses and the interconnection medium. The focusing apparatuses are connected to the end surfaces of the transmission apparatuses, and the interconnection medium is suspended in space and is not adsorbed on a surface of a component. The focusing apparatuses focus the light beam emitted by the transmission apparatuses to form the focused light beam, so as to form the capturing optical field, and an optical force and a moment are generated near a focus of the focused light beam, such that the capturing optical field captures the interconnection medium suspended in the space to a position between the focusing apparatuses in response to the need for interconnection and communication of the signal, and an optical wave signal in one transmission apparatus is transmitted to the other transmission apparatus through the interconnection medium, so as to achieve optical interconnection.

In addition, the present disclosure further provides a processor and a server having the above advantages.

### BRIEF DESCRIPTION OF THE DRAWINGS

In order to more clearly illustrate the technical solutions in the embodiments of the present disclosure or in the related art, the accompanying drawings required for the description of the embodiments or the related art will be briefly introduced below. Obviously, the accompanying drawings in the following description are only some embodiments of the present disclosure, and those of ordinary skill in the art would further be able to derive other accompanying drawings from these accompanying drawings without making creative efforts.

FIG. 1 is a basic schematic diagram of an optical tweezers technology;

FIG. 2 is a side view of an optical interconnection interface according to an embodiment of the present disclosure;

FIG. 3 is a top view of an optical interconnection interface according to an embodiment of the present disclosure;

FIG. 4 is a schematic diagram of a focus formed by two nanofocusing lenses in an embodiment of the present disclosure;

FIG. 5 is another schematic diagram of a focus formed by two nanofocusing lenses in an embodiment of the present disclosure;

FIG. 6 is a diagram showing position relations between a nanowire and a first waveguide and between the nanowire and a second waveguide when a polarization direction of a laser beam is in a horizontal direction in an embodiment of the present disclosure; and

FIG. 7 is a diagram showing position relations between a nanowire and a first waveguide and between the nanowire and a second waveguide when a polarization direction of a laser beam is in a vertical direction in an embodiment of the present disclosure.

In the figures:
1, Transmission apparatus; 2, Focusing apparatus; 3, Interconnection medium; and 4, Substrate.

### DETAILED DESCRIPTION OF THE EMBODIMENTS

In order to make those skilled in the art better understand the solution of the present disclosure, the present disclosure will be further described in detail below with reference to the accompanying drawings and the particular embodiments. Apparently, the embodiments described are merely some embodiments rather than all embodiments of the present disclosure. On the basis of the embodiments in the present disclosure, all other embodiments obtained by those of ordinary skill in the art without making creative efforts fall within the scope of protection of the present disclosure.

Many specific details are set forth in the following description to fully understand the present disclosure, but the present disclosure can further be implemented in other ways different from those described herein, similar derivatives can be made by those skilled in the art without departing from the connotation of the present disclosure, and therefore the present disclosure is not limited by the specific embodiments disclosed below.

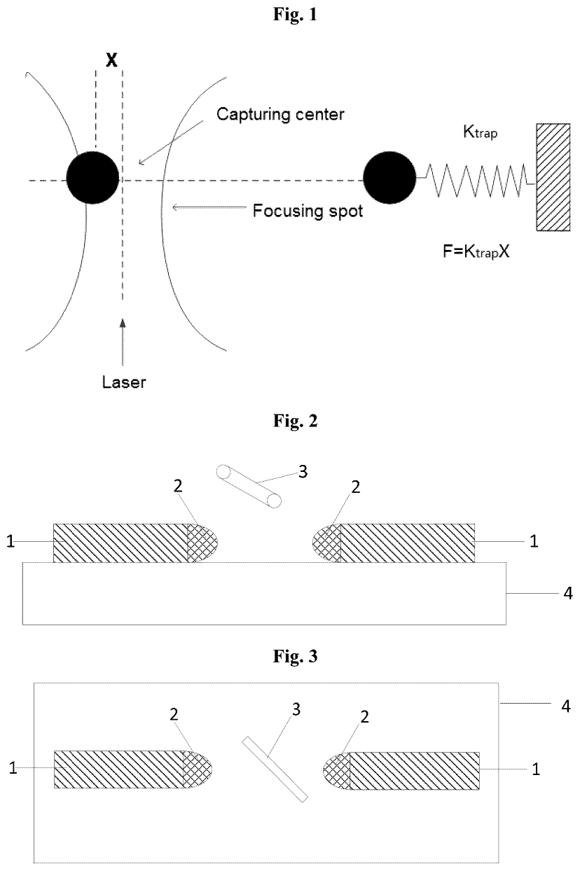

A basic schematic diagram of an optical tweezers technology is shown in FIG. 1. Dielectric particles may be attracted to a center of a focus of a light beam. A force acting on an object is proportional to a distance from the object to a center of the light beam, like a spring system. The optical tweezers technology belongs to an advanced laser technology, a core of the technology lies in mechanics and moment effects generated by means of momentum transfer between light and material particles, and three-dimensional high-precision manipulation of the microscopic object is achieved by means of the mechanics and moment effects. Different from mechanical clamping in a traditional sense, the optical tweezers technology manipulates a spatial position of matter, for example, captures, moves and arranges the matter, by means of a tiny force generated by interaction between light and the matter. The process has the advantages of non-contact, low damage and strong penetration.

As described in the background, for the current on-processor optical tweezers technology, nanoscale particles may only be adsorbed onto a surface of a processor structure, and may not be spatially suspended or achieve an on-processor optical interconnection effect.

In view of this, the present disclosure provides an optical interconnection interface. With reference to FIGS. 2-3, a side view and a top view of an optical interconnection interface according to an embodiment of the present disclosure are shown separately. The optical interconnection interface includes:

two transmission apparatuses 1 for transmitting a light beam, where end surfaces of the two transmission apparatuses 1 are oppositely arranged;

two focusing apparatuses 2 for focusing the light beam emitted by the two transmission apparatuses 1 and forming a focused light beam, where the two focusing apparatuses 2 are connected to the two opposite end surfaces of the two transmission apparatuses 1 respectively; and an interconnection medium 3, where the interconnection medium is in a suspended state; the interconnection medium 3 is captured by a capturing optical field between the two focusing apparatuses 2 and is located between the two focusing apparatuses 2 in response to a need for interconnection and communication of a signal.

The transmission apparatuses 1 and the focusing apparatuses 2 may be arranged on a substrate 4. The substrate 4 includes, but not limited to, a glass substrate.

The focusing apparatuses 2 are located at the two opposite end surfaces of the transmission apparatuses 1. That is, the two focusing apparatuses 2 are also oppositely arranged, as shown in FIGS. 2-3. The end surfaces of the two transmission apparatuses 1 are oppositely arranged. That is, axes of the two transmission apparatuses 1 are on the same straight line, as shown in FIGS. 2-3.

The interconnection medium 3 is suspended and does not make contact with any component. A position of the interconnection medium 3 is not fixed in space in response to no performing for interconnection and communication of the signal.

The focusing apparatuses 2 focus the light beam emitted by the two transmission apparatuses 1 to form the focused light beam, so as to form the capturing optical field, and an optical force and a moment may be generated near a focus of the focused light beam, such that the suspended interconnection medium 3 may be captured between the two focusing apparatuses 2.

In an embodiment, the two transmission apparatuses 1 are waveguides, and certainly, may also be other apparatuses capable of transmitting the laser beams, which are not specifically limited in the present disclosure.

In an embodiment, the two focusing apparatuses 2 are nanofocusing lenses, and certainly, may also be other apparatuses capable of focusing the laser beams, which are not specifically limited in the present disclosure.

In an embodiment, the interconnection medium 3 is a nanowire, and an included angle between a long axis of the nanowire and an axis of each transmission apparatus 1 is adjusted according to a polarization property of the focused light beam.

It should be noted that a shape of end surfaces of the waveguides is not specifically limited in the present disclosure, and may be configured voluntarily. For example, the waveguides may have an end surface shape of a rectangle, a square, a trapezoid, a hexagon and a circle.

The waveguides may have a thickness ranging from 50 nm to 300 nm (nanometers). For example, the waveguides may have the thickness of 50 nm, 80 nm, 100 nm, 150 nm, 200 nm, 210 nm, 220 nm, 230 nm, 240 nm, 280 nm or 300 nm. The waveguides may have a width ranging from 50 nm to 300 nm. For example, the waveguides may have a width of 50 nm, 80 nm, 100 nm, 150 nm, 200 nm, 210 nm, 220 nm, 230 nm, 240 nm, 280 nm or 300 nm.

The nanofocusing lenses may have a hemispherical shape, and may have a diameter ranging from 50 nm to 350 nm. For example, the nanofocusing lenses may have a diameter of 50 nm, 80 nm, 100 nm, 150 nm, 200 nm, 210 nm, 220 nm, 230 nm, 240 nm, 250 nm, 280 nm, 330 nm or 350 nm.

It should also be noted that a cross-section shape of the nanowire is not specifically limited in the present disclosure, and may be configured voluntarily. For example, the cross-section shape of the nanowire includes, but not limited to, any one of a circle, an ellipse, a rectangle, a triangle, and a hexagon.

In an embodiment, in order to simplify a process for manufacturing the nanowire, the nanowire has the cross-section shape of the circle. That is, the nanowire has a cylindrical shape.

When the nanowire has the cross-section shape of the circle, the nanowire may have a cross-section diameter ranging from 10 nm to 250 nm. For example, the nanowire may have the cross-section diameter of 10 nm, 30 nm, 50 nm, 60 nm, 70 nm, 80 nm, 90 nm, 100 nm, 110 nm, 120 nm, 130 nm, 140 nm, 150 nm, 200 nm, 230 nm or 250 nm.

For convenience of description, the two waveguides are referred to as a first waveguide and a second waveguide respectively. Correspondingly, the nanofocusing lens connected to an end surface of the first waveguide is referred to as a first nanofocusing lens, and the nanofocusing lens connected to an end surface of the second waveguide is referred to as a second nanofocusing lens.

Excitation light sources of the first waveguide and the second waveguide are lasers, and the lasers may be single-mode fiber lasers or multi-mode fiber lasers. The lasers emits laser beams into the first waveguide and the second waveguide, the laser beams propagate in the first waveguide and the second waveguide respectively, the light beam in the first waveguide is emitted from the first waveguide and focused by the first nanofocusing lens to form a focused light beam, the light beam in the second waveguide is emitted from the second waveguide and focused by the second nanofocusing lens to form a focused light beam, and the capturing optical field for capturing the nanowire is formed between the first nanofocusing lens and the second nanofocusing lens. The two focused light beams intersect in the space at an angle, which is similar to a converging light beam generated by a traditional spatial optical tweezers technology. Thus, the optical force and the moment may be generated near the focused light beam to capture and manipulate the nanowire suspended in the space. It may be understood that no optical focus may be formed between the first nanofocusing lens and the second nanofocusing lens when the first waveguide and the second waveguide have no optical wave signal. Thus, the captured nanowire is also released and suspended in the space anew.

The nanowires that may be captured by the capturing optical field differ according to wavelengths of the laser beams emitted by the lasers, and the wavelengths of the laser beams may be configured according to sizes of the nanowires and positions of the nanowires suspended in the space. For example, the excitation light sources of the first waveguide and the second waveguide are the single-mode fiber lasers having a wavelength of 1550 nm.

It should be noted that a distance between the first nanofocusing lens and the second nanofocusing lens is not limited in the present disclosure, and may be determined according to cases.

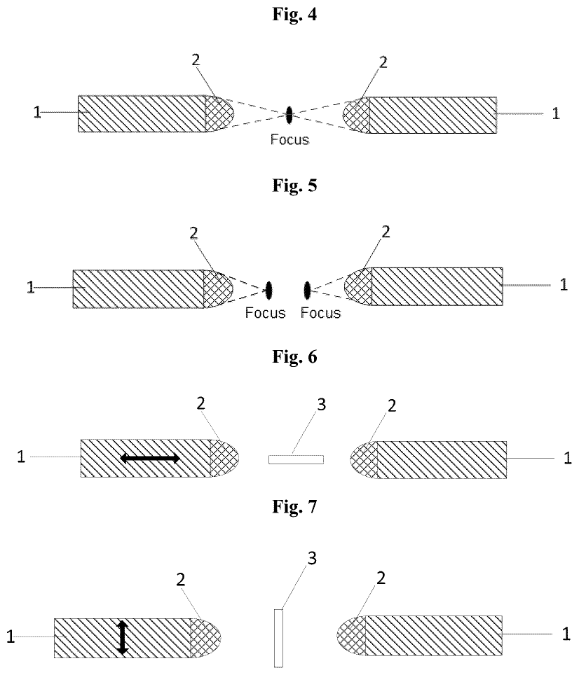

In an embodiment of the present disclosure, with reference to FIG. 4, a schematic diagram of a focus formed by two nanofocusing lenses according to an embodiment of the present disclosure is shown. Focuses of the two nanofocusing lenses intersect at the same point. That is, a focused light beam formed by focusing of the first nanofocusing lens and a focused light beam formed by focusing of the second nanofocusing lens intersect at the same point.

In another embodiment of the present disclosure, with reference to FIG. 5, another schematic diagram of a focus formed by two nanofocusing lenses in an embodiment of the present disclosure is shown. A distance between focuses of the two nanofocusing lenses is greater than zero. That is, focuses of the first nanofocusing lens and the second nanofocusing lens do not intersect at the same point, and a focused light beam formed by focusing of the first nanofocusing lens and a focused light beam formed by focusing of the second nanofocusing lens have two points of intersection in space.

Regardless of whether the focuses of the first nanofocusing lens and the second nanofocusing lens intersect at the same point, a shape of a capturing optical field may be adjusted by adjusting a distance between the first waveguide and the second waveguide, i.e. adjusting a distance between the first nanofocusing lens and the second nanofocusing lens. When the distance between the first nanofocusing lens and the second nanofocusing lens is short, an extremely compact capturing optical field may be formed between the first nanofocusing lens and the second nanofocusing lens, and the capturing optical field between the first nanofocusing lens and the second nanofocusing lens is stretched in an axial direction along with extension of the distance between the first nanofocusing lens and the second nanofocusing lens.

Different polarization properties of laser beams emitted by lasers into the first waveguide and the second waveguide cause different manipulation actions of the nanowire. For example, when linearly polarized light is transmitted in the first waveguide and the second waveguide, a long axis of the nanowire may be in a polarization direction due to a moment, as shown in FIGS. 6-7. In FIG. 6, a diagram showing position relations between the nanowire and the first waveguide and between the nanowire and the second waveguide when a polarization direction of a laser beam is in a horizontal direction is shown. When polarization directions of laser beams transmitted in the first waveguide and the second waveguide are in the horizontal direction, a long axis of the nanowire is also in the horizontal direction, and included angles between the long axis of the nanowire and an axis of the first waveguide and between the nanowire and an axis of the second waveguide are 0°. In FIG. 7, a diagram showing position relations between the nanowire and the first waveguide and between the nanowire and the second waveguide when a polarization direction of a laser beam is in a vertical direction is shown. When polarization directions of laser beams transmitted in the first waveguide and the second waveguide are in the vertical direction, a long axis of the nanowire is also in the vertical direction, and included angles between the long axis of the nanowire and an axis of the first waveguide and between the nanowire and an axis of the second waveguide are 90°. When circularly polarized light is transmitted in the first waveguide and the second waveguide, the nanowire may self-rotate near focuses of a first nanofocusing lens and a second nanofocusing lens.

The first nanofocusing lens and the second nanofocusing lens are both a pair of focusing lenses and a pair of optical tweezers devices. According to a theory of an optical tweezers technology, the nanowire may be captured near the focus formed by the first nanofocusing lens and the second nanofocusing lens by an optical force. Moreover, polarization properties of light of the focused light beam near the focus may spatially rotate and manipulate the nanowire. That is, the interface for a processor in the present disclosure achieves interconnection and communication of a signal by capturing and manipulating the nanowire on the basis of an on-processor optical tweezer composed of the first nanofocusing lens and the second nanofocusing lens, positions of the focuses of the first nanofocusing lens and the second nanofocusing lens are adjustable and controllable, and a position and an angle of the nanowire are adjustable and controllable.

The nanowire is similar to a wire in an electronic circuit, and may transmit an optical wave and a signal from the first waveguide to the second waveguide, or transmit the optical wave and the signal from the second waveguide to the first waveguide. The nanowire builds a bridge for interconnection between the first waveguide and the second waveguide. When the included angles between the long axis of the nanowire and the axis of the first waveguide and between the long axis of the nanowire and the axis of the second waveguide are 0°, that is, when the long axis of the nanowire is consistent with a direction of the first waveguide and a direction of the second waveguide, an obvious discontinuous phenomenon of an optical field may not appear on a propagation optical path. Thus, efficient on-processor interconnection may be achieved. On the contrary, when the included angles between the long axis of the nanowire and the axis of the first waveguide and between the long axis of the nanowire and the axis of the second waveguide are not 0°, that is, when the long axis of the nanowire is inconsistent with the direction of the first waveguide and the direction of the second waveguide, materials (the first waveguide, the second waveguide, the first nanofocusing lens, the second nanofocusing lens, and media around the nanowire, such as air and water) having different refractive indexes may appear on the propagation optical path. Thus, a sudden change in a refractive index exists on the propagation optical path, and optical interconnection efficiency is also reduced accordingly. When a direction of the long axis of the nanowire is perpendicular to a direction of a waveguide, that is, the included angles between the long axis of the nanowire and the axis of the first waveguide and between the long axis of the nanowire and the axis of the second waveguide are 90°, as shown in FIG. 7, the optical interconnection efficiency is the lowest. Optical interconnection and signal interaction between the first waveguide and the second waveguide are completed by means of the nanowire suspended in the space.

A transmission process will be described by taking transmission of an optical wave signal from the first waveguide to the second waveguide as an example. A laser beam is emitted into the first waveguide, enters the nanowire through the first nanofocusing lens, then is transmitted from the nanowire to the second nanofocusing lens, and is transmitted to the second waveguide by the second nanofocusing lens, and a signal received in the second waveguide may be analyzed by a related signal analysis component. It should be noted that when signals need to be repeatedly transmitted into the second waveguide, signals transmitted next time may be transmitted into the second waveguide after the second waveguide has no signal transmitted last time, or may be transmitted into the second waveguide when the second waveguide still has a signal transmitted last time. That is, the transmitted signals are overlapped in the second waveguide.

The optical interconnection interface in the present disclosure is a point-to-point on-processor optical communication link, is designed as a pure optical path, avoids the problem of light-power-light signal conversion existing in a traditional interconnection technology by means of a light-controlling-light technology, and thus has extremely important significance for development of a modern high-speed large-capacity optical communication network. The link connects two computing cores (laser beams in two waveguides) on the processor by means of the optical tweezers technology such that data may be transmitted at a high speed, and reliability of data communication and processing in an on-processor optical network system may be effectively improved. Moreover, the interface has compact structure, low loss, simple structure and easy implementation.

The optical interconnection interface in the present disclosure includes the transmission apparatuses, the focusing apparatuses and the interconnection medium. The focusing apparatuses are connected to the end surfaces of the transmission apparatuses, and the interconnection medium is suspended in the space and is not adsorbed on a surface of a component. The focusing apparatuses focus the light beams emitted by the transmission apparatuses to form the focused light beam, so as to form the capturing optical field, and the optical force and the moment are generated near a focus of the focused light beam, such that the capturing optical field captures the interconnection medium suspended in the space to a position between the focusing apparatuses when interconnection and communication of the signal are needed, and an optical wave signal in one transmission apparatus is transmitted to the other transmission apparatus through the interconnection medium, so as to achieve optical interconnection.

In an embodiment of the present disclosure, the nanowire in an optical interconnection interface is a nanowire of a single size, a capturing optical field between the first nanofocusing lens and the second nanofocusing lens only captures the nanowire of one size. When a signal needs to be transmitted between the first waveguide and the second waveguide, excitation light sources (lasers) of the first waveguide and the second waveguide only need to emit laser of one wavelength.

At present, most of optical processing devices may only complete a specific single optical processing function, and have poor flexibility. With a demand of an optical signal processing application, it is usually required that the on-processor optical processing device has tuning and reconfiguration functions to some extent. To solve the problem, in an embodiment of the present disclosure, the nanowire in an optical interconnection interface has at least two different sizes.

A size of the nanowire includes, but not limited to, a cross-section diameter and a length. Certainly, the nanowire may also have a plurality of cross-section shapes, which all fall within the scope of protection of the present disclosure.

When the optical interconnection interface includes a plurality of nanowires of different sizes, all the nanowires are suspended in space, and the nanowires of different sizes need different capturing optical fields to be manipulated, so as to adjust positions. For example, when the optical interconnection interface includes N (N is greater than or equal to 2) nanowires having circular cross-section shapes, a nanowire of a first size has a length of L1 and a circular cross-section diameter of D1, a nanowire of a second size has a length of L2 and a circular cross-section diameter of D2, a nanowire of a third size has a length of L3 and a circular cross-section diameter of D3, and so on, and a nanowire of an Nth size has a length of LN and a circular cross-section diameter of DN.

When the nanowire of the first size is needed, a capturing optical field is needed to capture the nanowire of the first size, and a position of the nanowire of the first size is adjusted to a position between the first nanofocusing lens and the second nanofocusing lens; when the nanowire of the second size is needed, a second capturing optical field is needed to capture the nanowire of the second size, and a position of the nanowire of the second size is adjusted to a position between the first nanofocusing lens and the second nanofocusing lens, and so on; and when the nanowire of the Nth size is needed, an Nth capturing optical field is needed to capture the nanowire of the Nth size, and a position of the nanowire of the Nth size is adjusted to a position between the first nanofocusing lens and the second nanofocusing lens.

Factors affecting the capturing optical field between the first nanofocusing lens and the second nanofocusing lens include a wavelength of a focused light beam. That is, when the nanowire of the first size needs to be captured, an excitation light source (laser) of the waveguide may be controlled to emit a laser beam having a wavelength of λ1; when the nanowire of the second size needs to be captured, the excitation light source (laser) of the waveguide may be controlled to emit a laser beam having a wavelength of λ2; when the nanowire of the third size needs to be captured, the excitation light source (laser) of the waveguide may be controlled to emit a laser beam having a wavelength of λ3, and so on; and when the nanowire of the Nth size needs to be captured, the excitation light source (laser) of the waveguide may be controlled to emit a laser beam having a wavelength of λN.

Emission wavelengths of the excitation light source lasers of the first waveguide and the second waveguide may be adjusted by means of computer software programming, such that optical tweezers characteristics may be multi-functionally and dynamically adjusted, and tuning and reconstruction functions may be achieved to some extent. The optical interconnection interface in the embodiment has programmability, such that system upgrade is facilitated.

In order to avoid a Joule heating effect and a plasma effect at the optical interconnection interface, in an embodiment of the present disclosure, the waveguides, the nanofocusing lenses and the nanowire are all made of non-metallic materials. That is, the first waveguide, the second waveguide, the first nanofocusing lens, the second nanofocusing lens and all the nanowires are all made of non-metallic materials.

It should be noted that the non-metallic materials are not limited in the present disclosure, as long as the non-metallic materials all fall within the scope of protection of the present disclosure.

In an embodiment of the present disclosure, the waveguides, the nanofocusing lenses and the nanowire are all made of silicon. That is, the first waveguide and the second waveguide are a first silicon waveguide and a second silicon waveguide respectively, the first nanofocusing lens and the second nanofocusing lens are a first silicon nanofocusing lens and a second silicon nanofocusing lens respectively, and the nanowire is a silicon nanowire.

When the first waveguide, the second waveguide, the first nanofocusing lens, the second nanofocusing lens and all the nanowires are all made of silicon, that is, the optical interconnection interface is made of an all-silicon material, a problem of processor heating may be avoided; moreover, silicon is a material having a large storage amount in nature and low cost, is almost transparent in a near infrared band and even in a middle infrared band, and further has extremely low material loss, and a large refractive index difference of a silicon insulator waveguide is also more conducive to high-density integration of a device; and more importantly, a silicon material is compatible with an existing mature electrical complementary metal oxide semiconductor (CMOS) process, such that the optical interconnection interface in the present disclosure does not need to develop a separate manufacturing process, thereby being more conducive to production.

In an embodiment of the present disclosure, end surfaces of the waveguides are located in a range of surfaces connected to a nanofocusing lenses. That is, a projection of an end surface of the first waveguide on the first nanofocusing lens connected to the first waveguide is completely located in a surface connected to the first nanofocusing lens, and a projection of an end surface of the second waveguide on the second nanofocusing lens connected to the second waveguide is completely located in a surface connected to the second nanofocusing lens.

It should be noted that in the embodiment, a size relation between end surfaces of the waveguides and surfaces of the nanofocusing lenses connected to the waveguides includes two types. A first type is that a size of end surfaces of the waveguides is less than a size of surfaces of the nanofocusing lenses connected to the waveguide, and a second type is that a size of end surfaces of the waveguides is equal to a size of surfaced of the nanofocusing lenses connected to the waveguides. However, this is not specifically limited in the present disclosure. The size of end surfaces of the waveguides may also be less than the size of surfaces of the nanofocusing lenses connected to the waveguides. However, it should be noted that a size difference between the size of end surfaces of the waveguides and the size of surfaces of the nanofocusing lenses connected to the waveguides should not be too great, and it is necessary to ensure that a laser beam transmitted in the waveguides may enter the nanofocusing lenses.

When end surfaces of the waveguides are located in the range of surfaces connected to the nanofocusing lenses, the nanofocusing lenses may focus all laser beams transmitted in the waveguidees to the greatest extent.

In an embodiment of the present disclosure, two transmission apparatuses 1 of an optical interconnection interface are arranged on the same processor. That is, when the first waveguide, the first nanofocusing lens connected to an end surface of the first waveguide, the second waveguide and the second nanofocusing lens connected to an end surface of the second waveguide are all arranged on one processor when the transmission apparatuses 1 are waveguides and the focusing apparatuses 2 are nanofocusing lenses, interconnection in the processor may be achieved by means of the optical interconnection interface in the present disclosure. However, this is not specifically limited in the present disclosure. In another embodiment of the present disclosure, two transmission apparatuses 1 are arranged on different processors. That is, when the first waveguide and the first nanofocusing lens connected to an end surface of the first waveguide are arranged on one processor and the second waveguide and the second nanofocusing lens connected to an end surface of the second waveguide are arranged on the other processor when the transmission apparatuses 1 are waveguides and the focusing apparatuses 2 are nanofocusing lenses, interconnection between the processors may be achieved by means of the optical interconnection interface in the present disclosure.

In order to simplify a process for manufacturing the optical interconnection interface and improve manufacturing efficiency of the optical interconnection interface, in an embodiment of the present disclosure, each focusing apparatus 2 and each transmission apparatus 1 connected to the focusing apparatus 2 are of an integrated structure. That is, when the transmission apparatuses 1 are waveguides and the focusing apparatuses 2 are nanofocusing lenses, the first waveguide and the first nanofocusing lens connected to an end surface of the first waveguide are of an integrated structure, and the second waveguide and the second nanofocusing lens connected to an end surface of the second waveguide are of an integrated structure.

The first waveguide and the second waveguide having cuboid shapes are taken as an example. When the optical interconnection interface is manufactured, a silicon strip body is prepared, part of the silicon strip body correspondingly manufacturing the first waveguide is manufactured into the first waveguide having a required size, and then part of the silicon strip body correspondingly manufacturing the first nanofocusing lens is manufactured into a hemispherical first nanofocusing lens. Similarly, another silicon strip body is prepared, part of the silicon strip body correspondingly manufacturing the second waveguide is manufactured into the second waveguide having a required size, and then part of the silicon strip body correspondingly manufacturing the second nanofocusing lens is manufactured into a hemispherical second nanofocusing lens. It may be understood that since a nanowire is suspended and does not make contact with any component, the nanowire needs to be manufactured separately. When the first nanofocusing lens and the first waveguide are seamlessly integrated, and the second nanofocusing lens and the second waveguide are seamlessly integrated, scale integration is facilitated, and manufacturing efficiency of the optical interconnection interface is improved.

In an embodiment of the present disclosure, each focusing apparatus of an optical interconnection interface is connected to each transmission apparatus in an adhesive manner. That is, the first waveguide is connected to the first nanofocusing lens connected to an end surface of the first waveguide in an adhesive manner, and the second waveguide is connected to the second nanofocusing lens connected to an end surface of the second waveguide in an adhesive manner.

When the optical interconnection interface in the in an adhesive manner is manufactured, the first waveguide, the second waveguide, the first nanofocusing lens and the second nanofocusing lens need to be manufactured separately, then the end surface of the first waveguide is connected to the first nanofocusing lens by means of an adhesive, and the end surface of the second waveguide is connected to the second nanofocusing lens by means of an adhesive. Compared with the above in an adhesive manner in which the first waveguide and the first nanofocusing lens are of an integrated structure and the second waveguide and the second nanofocusing lens are of an integrated structure, in the in an adhesive manner, an additional step of the adhesive is needed. Thus, a manufacturing process is relatively complex.

The optical interconnection interface in the present disclosure will be described below in a specific case.

The optical interconnection interface includes a first silicon strip waveguide, a second silicon strip waveguide, a first hemispherical silicon nanofocusing lens, a second hemispherical silicon nanofocusing lens and a silicon nanowire. End surfaces of the first silicon strip waveguide and the second silicon strip waveguide are oppositely arranged, the first hemispherical silicon nanofocusing lens is connected to the end surface of the first silicon strip waveguide opposite the second silicon strip waveguide, the second hemispherical silicon nanofocusing lens is connected to the end surface of the second silicon strip waveguide opposite the first silicon strip waveguide, and the silicon nanowire is suspended in space, and has a cylindrical shape. An ambient medium may be air or water.

The first silicon strip waveguide and the second silicon strip waveguide are arranged on a glass substrate, the first silicon strip waveguide and the second silicon strip waveguide have thicknesses ranging from 200 nm to 240 nm, and the first silicon strip waveguide and the second silicon strip waveguide have widths ranging from 200 nm to 240 nm; the first hemispherical silicon nanofocusing lens and the second hemispherical silicon nanofocusing lens have diameters ranging from 200 nm to 250 nm; and the silicon nanowire has a diameter ranging from 50 nm to 150 nm. The optical interconnection interface in the embodiment has the following advantages:

Firstly, the first silicon strip waveguide, the second silicon strip waveguide, the first hemispherical silicon nanofocusing lens, the second hemispherical silicon nanofocusing lens and the silicon nanowire are all made of silicon, and thus the problem of processor heating is avoided. A silicon material has the advantages of large storage amount in nature, low cost, near transparency in a near infrared band and even in a middle infrared band, and extremely low material loss, and a large relative refractive index difference of a silicon insulator waveguide is more conducive to high-density integration of a device. More importantly, the silicon material is compatible with an existing mature electrical CMOS process.

Secondly, the optical interconnection interface in the embodiment achieves interconnection and communication of the signal by capturing and manipulating the silicon nanowire on the basis of on-processor optical tweezers composed of the first hemispherical silicon nanofocusing lens and the second hemispherical silicon nanofocusing lens; optical controllability of an optical force and a moment forms programmable characteristics of the processor, and optical tweezers characteristics can be multi-functionally and dynamically adjusted by means of computer software programming; and the optical interconnection interface has programmability, such that system upgrade is facilitated. By adjusting optical field modes in the first silicon strip waveguide and the second silicon strip waveguide, the optical tweezer characteristics of the interface for a processor and a relative position of the silicon nanowire may also be adjusted to better focus the light beam and multi-functionally manipulate the silicon nanowire, so as to design a processor having excellent performance.

Thirdly, the optical interconnection interface has compact structure, all-optical implementation, low loss, simple structure and easy implementation, the first silicon strip waveguide and the first hemispherical silicon nanofocusing lens can be seamlessly integrated, and the second silicon strip waveguide and the second hemispherical silicon nanofocusing lens may be seamlessly integrated, such that scale integration is facilitated.

Fourthly, on-processor interconnection is achieved on the basis of the optical tweezers technology, and the present disclosure may further be extended and applied to aspects such as biological sensing, quantum computing and weak physical field detection, and has wide application range and strong expandability.

The present disclosure further provides a processor. The processor includes the optical interconnection interface of any one of the above embodiments.

In an embodiment, one processor may be provided. Interconnection in the processor may be achieved when the optical interconnection interface is arranged on the processor. In another embodiment, two processors may be provided. Two transmission apparatuses 1 in the optical interconnection interface are arranged on different processors. That is, when the first waveguide and the first nanofocusing lens connected to an end surface of the first waveguide are arranged on one processor and the second waveguide and the second nanofocusing lens connected to an end surface of the second waveguide are arranged on the other processor when the transmission apparatuses 1 are waveguides and the focusing apparatuses 2 are nanofocusing lenses, interconnection between the processors may be achieved by means of the optical interconnection interface in the present disclosure.

In the optical interconnection interface for the processor in the embodiment, the optical interconnection interface includes the transmission apparatuses, the focusing apparatuses and the interconnection medium. The focusing apparatuses are connected to end surfaces of the transmission apparatuses, and the interconnection medium is suspended in space and is not adsorbed on a surface of a component. The focusing apparatuses focus light beams emitted by the transmission apparatuses to form a focused light beam, so as to form a capturing optical field, and an optical force and a moment are generated near a focus of the focused light beam, such that the capturing optical field captures the interconnection medium suspended in the space to a position between the focusing apparatuses in response to the need for interconnection and communication of a signal, and an optical wave signal in one transmission apparatus is transmitted to the other transmission apparatus through the interconnection medium, so as to achieve optical interconnection.

The present disclosure further provides a server. The server includes the processor of the above embodiment.

Various embodiments in the specification are described in a progressive manner, each embodiment focuses on the differences from other embodiments, and it is sufficient to refer to one another for the same and similar parts among various embodiments.

The optical interconnection interface, the processor and the server according to the present disclosure are introduced in detail above. Specific embodiments are used for illustrating principles and embodiments of the present disclosure herein. The description of the embodiments above is only used for helping understand the solution and core concept of the present disclosure. It should be noted that several improvements and modifications may further be made by those of ordinary skill in the technical field without departing from the principles of the present disclosure, which also fall within the scope of protection of the claims of the present disclosure.

1. An optical interconnection interface, comprising:
two transmission apparatuses for transmitting a light beam, wherein end surfaces of the two transmission apparatuses are oppositely arranged;
two focusing apparatuses for focusing the light beam emitted by the two transmission apparatuses and forming a focused light beam, wherein the two focusing apparatuses are connected to the two opposite end surfaces of the two transmission apparatuses respectively; and
an interconnection medium, wherein the interconnection medium is in a suspended state;
wherein the interconnection medium is captured by a capturing optical field between the two focusing apparatuses and is located between the two focusing apparatuses in response to a need for interconnection and communication of a signal.

2. The optical interconnection interface according to claim 1, wherein the two transmission apparatuses are waveguides.

3. The optical interconnection interface according to claim 2, wherein the two focusing apparatuses are nanofocusing lenses.

4. The optical interconnection interface according to claim 3, wherein the interconnection medium is a nanowire, and an included angle between a long axis of the nanowire and an axis of each transmission apparatus is adjusted according to a polarization property of the focused light beam.

5. The optical interconnection interface according to claim 4, wherein the nanowire has at least two different sizes.

6. The optical interconnection interface according to claim 4, wherein the waveguides, the nanofocusing lenses and the nanowire are all made of non-metallic materials.

7. The optical interconnection interface according to claim 6, wherein the waveguides, the nanofocusing lenses and the nanowire are all made of silicon.

8. The optical interconnection interface according to claim 3, wherein focuses of the two nanofocusing lenses intersect at the same point.

9. The optical interconnection interface according to claim 3, wherein a distance between focuses of the two nanofocusing lenses is greater than zero.

10. The optical interconnection interface according to claim 1, wherein the two transmission apparatuses are arranged on the same processor.

11. The optical interconnection interface according to claim 1, wherein the two transmission apparatuses are arranged on different processors.

12. The optical interconnection interface according to claim 4, wherein the nanowire has a cross-section shape of any one of a circle, an ellipse, a rectangle, a triangle and a hexagon.

13. The optical interconnection interface according to claim 12, wherein the nanowire has a cross-section diameter ranging from 10 nm to 250 nm in a case that the nanowire has the cross-section shape of the circle.

14. The optical interconnection interface according to claim 3, wherein end surfaces of the waveguides are located in a range of surfaces connected to the nanofocusing lenses.

15. The optical interconnection interface according to claim 2, wherein the waveguides have a thickness ranging from 50 nm to 300 nm and a width ranging from 50 nm to 300 nm.

16. The optical interconnection interface according to claim 2, wherein the waveguides have an end surface shape of any one of a rectangle, a square, a trapezoid, a hexagon and a circle.

17. The optical interconnection interface according to claim 3, wherein the nanofocusing lenses are hemispherical, and have a diameter ranging from 50 nm to 350 nm.

18. The optical interconnection interface according to claim 1, wherein;
each focusing apparatus and each transmission apparatus are of an integrated structure; or
each focusing apparatus is connected to each transmission apparatus in an adhesive manner.

19. (canceled)

20. A processor, comprising the optical interconnection interface according to claim 1.

21. A server, comprising the processor according to claim 20.
